(19) United States
(12) Patent Application Publication
(10) Pub. No.: US 2011/0115619 A1
(43) Pub. Date: May 19, 2011

(54) Rear Warning Lights Apparatus for Vehicles

(76) Inventor: Stephen R. Elliott, Bristol, IN (US)

(21) Appl. No.: 12/945,922

(22) Filed: Nov. 15, 2010

Related U.S. Application Data
(60) Provisional application No. 61/281,567, filed on Nov. 19, 2009.

(51) Int. Cl. B60Q 1/50

(52) U.S. Cl. 340/472

(57) ABSTRACT

A first embodiment 100 discloses a traffic control arm having warning lights operationally coupled to a linear actuator attached to the rear of a vehicle. The actuator is switch activated that causes the traffic control arm to move horizontally extending out from the side of the vehicle a distance equivalent to the front driver's door being fully extended, and also retract to a position centrally located at the rear of the vehicle. The warning lights are switch activated and may be used separately or in conjunction with the traffic control arm. The lights connect to a programmable lights controller that can be adjusted to perform different lighting functions. All components are powered off the 12-volt power of the vehicle. A second embodiment 300 uses a rotational actuator that replaces the linear actuator of the first embodiment 100.

### CROSS-REFERENCE TO RELATED APPLICATIONS

This application claims the benefit of the U.S. Provisional Patent Application No. 61/281,567 filed Nov. 19, 2009 by the present inventor. This provisional patent application is incorporated herein by reference.

### TECHNICAL FIELD

The invention presented herein applies to warning lights for emergency vehicles, more particularly to warning lights installed on the rear of a vehicle that provide added protection for the driver when exiting the vehicle.

### BACKGROUND OF THE DISCLOSURE

There is a need to create a safety zone where emergency vehicle operators such as law enforcement officers and other highway personnel can maneuver outside their vehicle. The objective is to protect the emergency person from approaching traffic coming from the rear when the emergency vehicle operator exits, enters and moves around his or her vehicle. This is best done by providing visible warnings to approaching vehicles so that they will slow down and maneuver around the vehicle cautiously, thereby providing a wide clearance around the emergency vehicle on the driver's side.

The use of flashing lights are extensively used for emergency police, fire, ambulance and other vehicles to warn other vehicles to avoid endangering the emergency vehicle's occupants. While these systems work when the vehicle is stopped as well as when the vehicle is in motion, emergency vehicle drivers are very vulnerable when they exit the vehicle.

There exist several proposed solutions that provide additional protection for the emergency vehicle driver when exiting the vehicle. Some involve providing lights on the door that flash when the door is opened. Another has an arm mounted on the top of the vehicle that pivots the arm so that it extends outwardly on the driver's side. However there is a need for a warning system that is easy to use and provides additional protection to the driver when exiting the vehicle.

### SUMMARY OF THE DISCLOSURE

In a first embodiment 100, a traffic control arm containing flashable warning lights is coupled to a linear actuator that is mountable on the rear of the vehicle. This device is powered by the vehicle's 12-volt primary power source, which includes a battery and an alternator. The traffic control arm is switch-activated and moves horizontally extending out on the driver's side of the vehicle a distance approximately equivalent to the front driver's door being fully extended. The apparatus is adjustable so the traffic control arm extends less than its maximum extent to accommodate restrictions in confined areas.

The flashable lighting is switch-activated and may be used separately or in conjunction with the traffic control arm. The lights connect to a 12-volt programmable control box and can be adjusted to perform different lighting functions.

A second embodiment uses a rotational actuator wherein the traffic control arm extends away for the vehicle on the driver's side by rotating 180 degrees from a retracted position to an extended position.

### BRIEF DESCRIPTION OF THE DRAWINGS

FIG. 1 illustrates a first embodiment of the invention.

FIG. 2 illustrates a perspective view of the warning lights assembly in a partially extended position.

FIG. 3 illustrates a first cross section of the traffic control arm and part of the linear actuator assembly.

FIG. 4 illustrates a second cross section of the traffic control arm and part of the linear actuator assembly.

FIG. 5 illustrates the warning lights assembly in a retracted position for a second embodiment of the invention.

FIG. 6 illustrates the warning lights assembly in a partially extended position for the second embodiment of the invention.

FIG. 7 illustrates an exploded view of the warning lights assembly of the second embodiment of the invention.

### DETAILED DESCRIPTION OF THE DISCLOSURE

The following terms and notation are used in this detailed description and in the appended claims. If there are more than one essentially identical items in a figure, the figure may show the associated numeral only once. The term horizontal refers to the ground when the traffic control arm is installed on a vehicle. The term warning lights assembly is defined to be any device that has flashable lights that may be used to warn approaching traffic near the vehicle on which the warning lights assembly is installed. The term traffic control arm refers to a component of a warning lights assembly that is movable relative to the vehicle that the warning lights assembly is mounted on. The term linear actuator assembly refers to any device that provides force in a linear direction. The term rotational actuator assembly refers to any device that applies force in a rotational direction. The term vehicle refers to any land vehicle of four or more wheels such as an automobile, truck, van, bus or pickup.

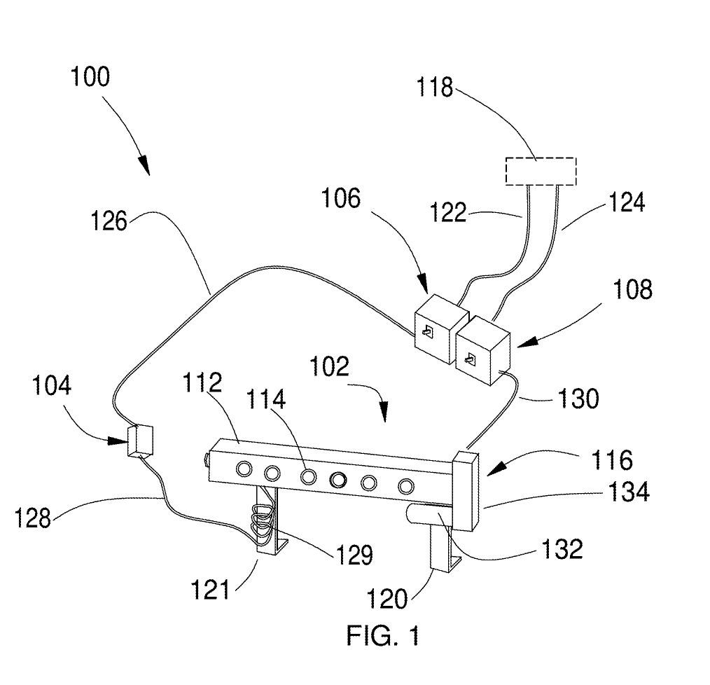

FIG. 1 displays the basic components of the first embodiment 100, which is comprised of a linear warning lights assembly 102 mountable on the rear of a vehicle, a lights controller 104 mountable on or inside the vehicle such as in the trunk of a police car, a lights control switch 106 and an actuator control switch 108; both switches mountable in the interior of the vehicle where they are accessible and visible to the driver.

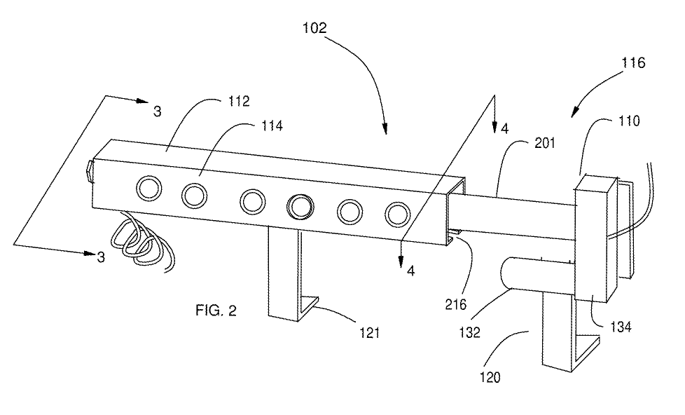

The linear warning lights assembly 102 is comprised of a traffic control arm 112, a linear actuator assembly 116 and two mounting brackets 120 and 121. The traffic control arm 112 is a rectangular tube 208 that extends and retracts by moving horizontally in a direction transverse to the driver's side of the vehicle. When in a retracted position, the traffic control arm 112 is positioned behind the vehicle centrally located behind or near the vehicle's bumper. When in an extended position, the traffic control arm 112 extends out from the driver's side of the vehicle up to a distance equivalent to the front driver's door that is fully extended. Located on the traffic control arm 112 are six light pods 114 that flash on and off. The flashing sequence is controlled by the lights controller 104. The linear actuator assembly 116 is comprised of an electric motor 132, a gearbox 134, and additional components illustrated in FIGS. 2 through 4.

The lights controller 104 is a programmable controller that determines the flashing sequence of the light pods 114. The lights controller has at least two flashable modes. A first flashable mode turns the flashable lights off. A second flashable mode turns the flashable lights on in a flashing sequence. Additional flashable modes may be implemented that provide additional flashing sequences.

The components are wired together as follows. The lights control switch 106 is wired using a first electrical wiring cable 122 to the vehicle's primary 12-volt power source 118. The actuator control switch 108 is wired using a second electrical wiring cable 124 to the vehicle power source 118. The lights controller 104 is wired using a third electrical wiring cable 126 to the lights control switch 106. The first electrical wiring cable 122, the second electrical wiring cable 124, and the third electrical wiring cable 126, as configured, comprise the lights controller wiring system. The linear actuator assembly 116 is wired by a fifth electrical wiring cable 130 to the actuator control switch 108. The lights controller 104 is wired using a sixth electrical wiring cable 128 to the light pods 114 on the traffic control arm 112, and includes a coil cable 129 at the end that attaches to the traffic control arm 112, thus accommodating the linear motion of the arm. The fifth electrical wiring cable 130, the sixth electrical wiring cable 128, and the coil cable 129, as configured, comprise the actuator assembly wiring system.

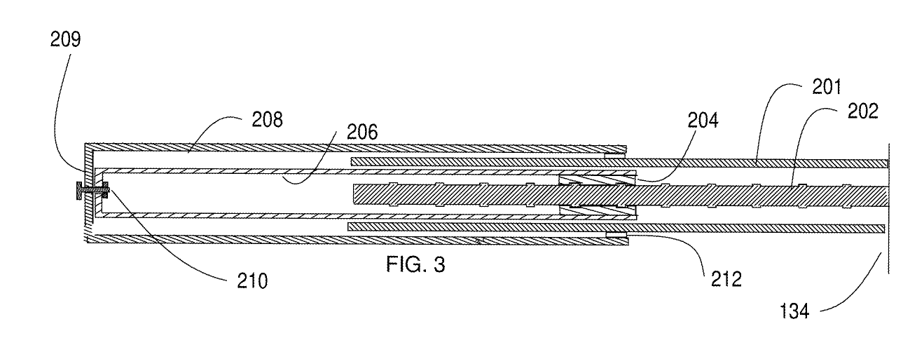

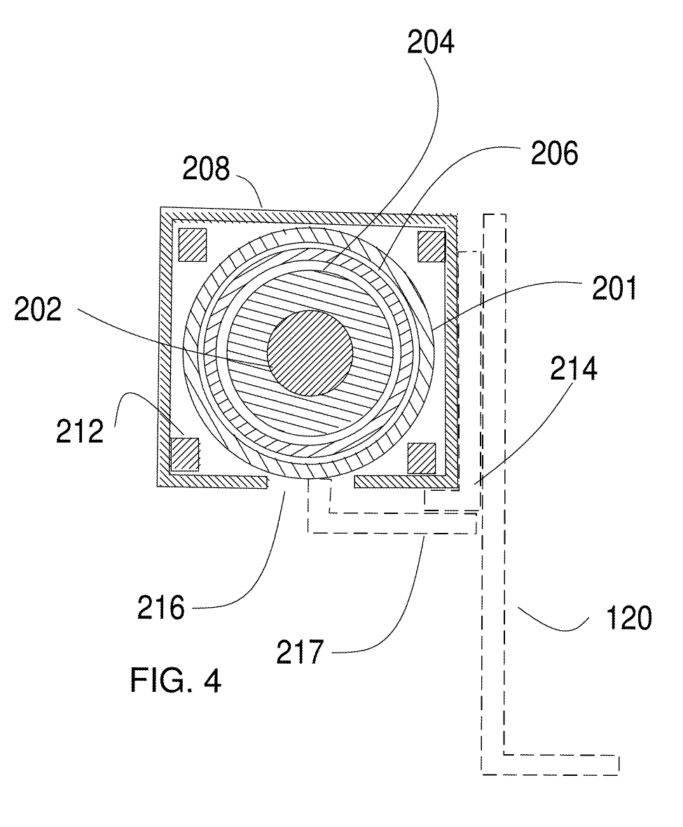

FIG. 2 illustrates the linear warning lights assembly 102 in a partially extended position. FIG. 2 also indicates the location of two cross sections. A first cross section 3, shown in FIG. 3 is taken horizontally. A second cross section 4, shown in FIG. 4, is taken perpendicular to the longitudinal axis of the traffic control arm 112 towards the end of the traffic control arm closest to the gearbox 134.

Referring to FIGS. 2 through 4, the linear actuator assembly 116 is comprised of an electric motor 132, a gearbox 134, an actuator arm 201, an actuator screw 202, an actuator nut 204 and a slidable tube 206. The actuator arm 201 is permanently attached to the two mounting brackets 120 and 121 via two small right-angle shaped brackets 217 (see FIG. 4) and also attached to the gearbox 134. The two mounting brackets 120 and 121 are mountable on the vehicle. When the actuator control switch 108 is activated to a switch first position, the linear actuator assembly 116 causes the traffic control arm 112 to extend to an assembly first position away from the vehicle on the driver' side. When the actuator control switch 108 is activated to a switch second position, it causes linear actuator assembly 116 to move traffic control arm 112 to an assembly second position to its retracted position as shown in FIG. 1. Also indicated in FIGS. 2 and 4 is a slot 216 located on the bottom of the rectangular tube 208, running the length of the tube. It provides clearance so the right-angle bracket can connect the actuator arm 201 to the two mounting brackets 120 and 121 by the right-angle shaped brackets 217, yet allow the traffic control arm to move slidingly relative to the actuator arm 201.

Referring again to FIGS. 2 through 4, the electric motor 132 is rotationally coupled to the gearbox 134, which is in turn rotationally coupled to an actuator screw 202. The actuator screw 202 is mated to an actuator nut 204. When the electric motor 132 shaft rotates, the actuator screw 202 rotates at a reduced speed. The actuator nut 204 is attached to a slidable tube 206. When the actuator screw 202 turns, the actuator nut 204 moves laterally along the screw, thereby moving the slidable tube 206 along with it. The slidable tube 206 is attached to a rectangular tube 208 via a nut and bolt 210. Nut and bolt 210 secures the slidable tube to a cap 209 secured on the end of the rectangular tube 208 farthest from the gearbox 134. Therefore, when the electric motor rotates, the rectangular tube 208 moves horizontally, in a direction that depends on the rotational direction of the electric motor 132.

Referring to FIGS. 3 and 4, the actuator arm 201 fits snugly within the rectangular tube 208. To accommodate the relative motion as the traffic control arm extends and retracts, four blocks 212 that facilitate sliding motion are positioned at the four inside corners of the rectangular tube 208 toward the end of the tube nearest the gearbox 134. An L-shaped tracking block 214, located on the mounting bracket 121 on the driver's side, constrains the rectangular tube from twisting while being extended or retracted.

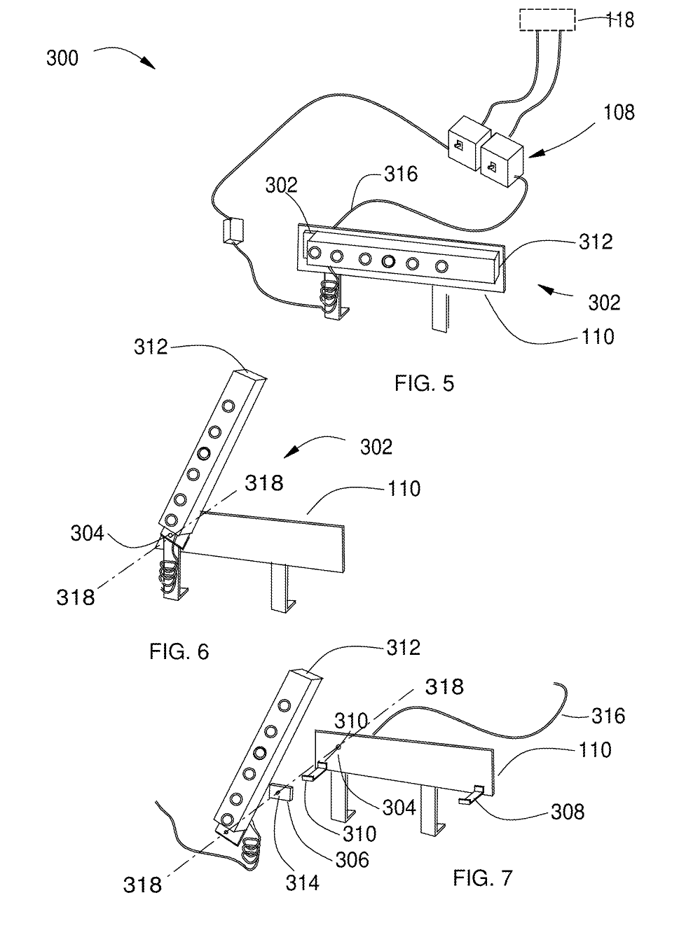

FIGS. 5 through 7 illustrate a second embodiment 300 of the invention. The main difference between the second embodiment 300 and the first embodiment 100 is that the linear warning lights assembly 102 of the first embodiment 100 is replaced by a rotational warning lights assembly 302 that pivots a rotational traffic control arm 312 about an axis 318 perpendicular to a backplate 110. When retracted, the rotational traffic control arm 312 remains horizontal and is centered at the rear of the vehicle. When extended, the rotational traffic control arm 312 rotates counterclockwise as seen standing behind the vehicle, up to 180 degrees. The actual location of the pivot point 304 is determined so that when rotated a full 180 degrees, the rotational traffic control arm 312 is extended the same distance as in the first embodiment 100.

FIG. 6 illustrates the rotational wanting lights assembly 302 when it is partially rotated about axis 318. FIG. 7 illustrates an exploded view of the rotational warning lights assembly 302. The rotational warning lights assembly 302 has a rotational actuator assembly 306 comprised of an electric motor/gearbox mechanism (the electric motor/gearbox details is not shown in the figures) that is attached to the backplate 110 and is wired using a sixth electrical wiring cable 316 to the actuator control switch 108. The rotational actuator assembly 306 provides rotational motion as compared to the linear actuator assembly 116 of embodiment one, which provides linear motion. The rotational actuator assembly 306 has a rotating shaft 314 that is bolted to the traffic control arm 112 so that the arm rotates with the shaft. Two brackets 308 and 310, located on a backplate 110, provide stops for the traffic control arm when in its retracted position and extended position respectively.

The operation of the rear warning light apparatus is the same for both the first and second embodiments. To turn off the light pods, the lights control switch 106 is put in the first flashing mode. To turn on the light pods, the lights control switch 106 is in the second flashing mode. To put the traffic control arm in its extended position, the actuator control switch 108 is put in switch first position. Similarly, when the actuator control switch 108 is put in the switch second position, the traffic control arm (112 for the first embodiment 100, 312 for the second embodiment 300) is retracted. Extension and retraction occurs linearly for embodiment one and rotationally for embodiment two.

Various enhancements to the first and second embodiments, consistent within the inventive concept of this specification may be implemented. The traffic control arm will stop and reverse to a safe place if it hits an obstruction. The flashable light pods turn on automatically as soon as the traffic control am starts to extend, and stays on until the traffic control arm is fully retracted. The traffic control arm is not allowed to extend when the vehicle is in motion. The lights controller may be incorporated in a light pods system rather than implemented as a separate component, or the light pods may flash on and off autonomously when turned on. The light pods may use LED lights or any other lights that are appropriate for emergency vehicle warning lights. The 12-volt power may be provided by an auxiliary 12-volt power source other that the vehicle's primary power source, and may use a voltage other than 12 volts. The number of light pods may differ from six, and may have different flashing characteristics. The actuators may have different implementations than as indicated above. The four blocks and the tracking block may be made of Delrin or out of another suitable material such as nylon. The rectangular tube may be made of a material such as aluminum, steel, or plastic, and may have a cross section other than rectangular. The lights control switch and the actuator control switch may be combined into a single switch that has a more sophisticated functionality. The actuator assembly may be comprised of a hydraulic, pneumatic or manual slide and the linear movement can be generated from other means such as, but not limited to, rack and pinion.

The disclosure presented herein gives two embodiments of the inventive concept. These embodiments are to be considered as only illustrative of the invention and not a limitation of the scope of the invention. Various permutations, combinations, variations and extensions of these embodiments are considered to fall within the scope of this invention. Therefore the scope of this invention should be determined with reference to the claims and not just by the embodiments presented herein.

What is claimed is:

1. An apparatus for mounting on a vehicle, the vehicle having a driver's side, a rear and a power source, the apparatus comprising:
a warning lights assembly comprising a traffic control arm, the traffic control arm containing a plurality of flashable lights;
the warning lights assembly is mountable at the rear of the vehicle and wherein the traffic control arm is extendable to an assembly first position away from the vehicle on the driver's side, and is also retractable to an assembly second position that is centrally located at the rear of the vehicle, and such the flashable lights are flashable when the traffic control arm is extended to the assembly first position.

2. The apparatus of claim 1 further comprising:
an actuator control switch, the actuator control switch having a switch first position that activates the traffic control arm to move away from the vehicle and a switch second position that activates the traffic control arm to retract; and
a linear actuator assembly that extends the traffic control arm to the assembly first position when the actuator control switch is activated to the switch first position, and furthermore retracts the traffic control arm to the assembly second position when actuator control switch is activated to the switch second position.

3. The apparatus of claim 2 further comprising an actuator wiring system, the actuator wiring system operationally couples the actuator control switch to the linear actuator assembly and to the power source.

4. The apparatus of claim 1 further comprising:
a lights controller, the lights controller having at least two flashable modes wherein a first flashable mode turns the flashable lights off, and a second flashable mode programmatically controls a first flashing sequence of the plurality of flashable lights.

5. The apparatus of claim 4 further comprising:
a lights control switch having at least two switch positions, a switch first position that activates the first flashable mode, and a switch second position that activates the second flashable mode.

6. The apparatus of claim 5 further comprising a lights control wiring system wherein the lights control wiring system operationally couples lights control switch to the lights controller and to the power source.

7. The power source of claim 1 wherein the power source is the vehicle's primary power source.

8. The power source of claim 1 wherein the power source is an auxiliary power source.

9. The apparatus of claim 1 further comprising:
an actuator control switch; the actuator control switch having a switch first position and a switch second position; and
a rotational actuator assembly that rotationally moves the traffic control arm to the assembly first position when the actuator control switch is activated to the switch first position, and furthermore rotationally moves the traffic control arm to the assembly second position when the actuator control switch is activated to the switch second position.
